(19) United States
(12) Patent Application Publication
(10) Pub. No.: US 2023/0258211 A1
(43) Pub. Date: Aug. 17, 2023

(54) FASTENING DEVICE

(71) Applicant: AFF GROUPE, MAZAMET (FR)

(72) Inventors: Mathieu AURIOL, FLOURENS (FR); Marc AURIOL, FLOURENS (FR); Didier CIZERON, MONISTROL-SUR LOIRE (FR)

(21) Appl. No.: 18/014,103

(22) PCT Filed: Jul. 2, 2021
(86) PCT No.: PCT/FR2021/051213

§ 371 Date: Dec. 30, 2022

(30) Foreign Application Priority Data
Jul. 2, 2020 (FR) FR2007020

(51) Int. Cl. F16B 5/06; F16B 2/14; F16B 3/06; F16B 7/04

(52) U.S. Cl. CPC F16B 5/0642; F16B 2/14; F16B 3/06; F16B 7/0473

(57) ABSTRACT

Disclosed is a device for fastening together two components to be joined, the device including a connection rod including two ends, a first end being fastened to a first component, the second end extending through the second component, the second end being having a bearing surface. This device is characterized in that it includes a clamping wedge which is associated with the second component and which is movable relative to the second component along an axis which is not parallel with the longitudinal axis of the connection rod and which is provided in an inclined plane, the wedge being interposed between the bearing surface of the second end of the connection rod and the surface of the second component so that, during its movement, the wedge, by way of its inclined plane, applies an axial constraint to the connection rod and ensures that the two components are fastened together.

### CROSS-REFERENCE TO RELATED APPLICATION(S)

This application is the U.S. national phase of International Application No. PCT/FR2021/051213 filed Jul. 2, 2021 which designated the U.S. and claims priority to FR2007020 filed Jul. 2, 2020, the entire contents of each of which are hereby incorporated by reference.

### BACKGROUND OF THE INVENTION

### Field of the Invention

The invention relates to the field of mechanical fastening and in particular to adaptations making it possible to improve the accessibility as well as the repeatability of fastenings.

### Description of the Related Art

In the field of assembly, it is known to attach the body of a vehicle to a chassis equipped with wheels. The assembly and disassembly of the bodywork are operations likely to be repeated.

Among the mechanical fastening devices, there are those using a screw/nut fastening. Such fasteners offer the possibility to implement the fastening while allowing disassembly.

Nevertheless, in general, such a fastening requires the possibility of direct access to the screw head and/or the nut in order to be able to rotate them, which in certain situations is not possible, such as for example in the fastening of a bodywork to its chassis which requires a point or a double bridge.

There exist offset axis screwing means, but a succession of screwing and unscrewing operations can harm the repeatability of the offered tightening.

In this respect, wear, the presence or absence of a lubricating material, are, among other things, parameters that for example can cause the tension achieved by the tightening to vary. This variation is not desirable, especially when fastening a bodywork to its chassis.

### SUMMARY OF THE INVENTION

Considering the above, the applicant has conducted research aimed at proposing a mechanical fastening device being:
removable,
accessible,
able to repeat the achieved tightening without variation.

Such a device can be applied in all areas of assembly such as automotive, building, aeronautics, railway, etc . . .

According to the invention, this fastening device for fastening together two components to be assembled comprises a connection rod comprising two ends, a first end being fastened to a first component, the second end passing through the second component, the second end being provided with a bearing surface, the device comprising a clamping wedge associated with the second component, movable relative to the second component along an axis which is not parallel to the longitudinal axis of the connection rod and which is formed with a inclined plane, and, fixed to the second component, a sleeve which passes through the second component and into the hollow core of which the connection rod is inserted during assembly,

said wedge being inserted between the bearing surface of the second end of the connection rod and the second component by bearing on the edge of said sleeve, so that in its movement, said wedge, by means of its inclined plane, exerts an axial stress on the connection rod and secures the two components.

This device is remarkable in that said connection rod comprises, between the bearing surface of its second end and the first component to which it is fastened, a ring whose outer surface cooperates with the hollow core of said sleeve.

This feature is particularly advantageous in that it makes it possible to assemble two components together with a greater strength by allowing several assembly/disassembly operations without degradation of the two components or of the constituent elements of the device and while maintaining the fastening conditions.

By allowing the clamping member to move along an axis that is not parallel to the longitudinal axis of the connection rod, such a device offers better accessibility. In this way, for example, fastening between a chassis fitted with the connection rods and the bodywork docking vertically allows fastening and removal to be controlled by lateral access without requiring the vehicle to be put on a lifting device.

An intermediate surface is inserted between the second component and the wedge so that once engaged with the connection rod, the clamping stress is exerted on the connection rod and on the sleeve and not directly on the second component. The second component is therefore not damaged during tightening.

The wedge can be mobile or fixed.

According to a preferred but non-limiting embodiment, the axis of motion of the clamping wedge is perpendicular to the longitudinal axis of the connection rod.

According to another particularly advantageous feature of the invention, said clamping wedge is configured as a fork whose branches are positioned on either side of the connection rod when they cooperate with the bearing surface. The use of a fork makes it possible to better transmit the effort.

According to another particularly advantageous feature of the invention, the inclined plane of the wedge comes in contact with the edge of the sleeve, which itself forms an inclined plane, in order to better transmit the effort.

According to another particularly advantageous feature of the invention, the outer surface of the ring is conical and cooperates with the hollow core of said sleeve, the latter being itself conical. This connection by embedding between the two cones will be maintained even if the wedge has an undesired movement.

According to a non-limiting embodiment, the two cones coming in contact have a same conicity.

According to a non-limiting embodiment, the two cones coming in contact have a different conicity.

According to another particularly advantageous feature of the invention, said movable wedge is set in motion by a movement-driving member.

According to a preferred but non-limiting embodiment, this movement-driving member is accessible from outside the second component.

According to another particularly advantageous feature of the invention, the movement-driving member comprises a threaded rod cooperating with an internally threaded fixed ring, fixed to the second component, said threaded rod comprising two ends:
a first end comprising a head making it possible to rotate the threaded rod,
a second end cooperating with the clamping wedge,
   so that the rotation of the screw in one direction or the other causes the translation of the clamping wedge in one direction or the other.

The wedge movement-driving member can be implemented by other technical solutions.

According to another particularly advantageous feature of the invention, said connection rod is a shouldered threaded shaft with a first threaded end fastened to the first component and a second end comprising a head providing said bearing surface.

According to another particularly advantageous feature of the invention, the components to be assembled form part of the subject matter of the invention.

The fundamental concepts of the invention having just been explained above in their most elementary form, other details and features will emerge more clearly on reading the description which follows and with regard to the appended drawings, giving by way of non-limiting example, an embodiment of a fastening device according to the invention.

### BRIEF DESCRIPTION OF THE DRAWINGS

FIG. 1 is a schematic drawing of a cross-sectional side view of the assembly of two components in the disassembled position;

FIG. 2 is a schematic drawing of a cross-sectional side view of the assembly of two components in the docked position;

FIG. 3 is a schematic drawing of a cross-sectional side view of the assembly of two components in the tightened position;

FIG. 4 is a schematic drawing of a detail cross-sectional side view of the assembly of two components in the fastened position.

### DESCRIPTION OF AN EMBODIMENT

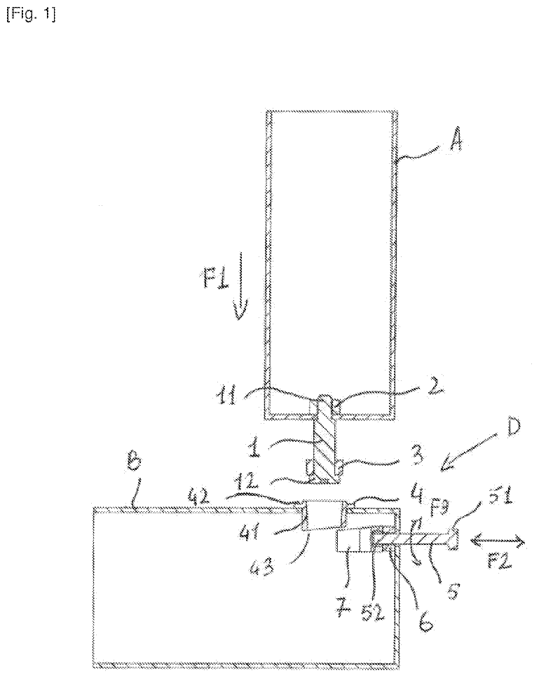

As shown by FIGS. 1 to 4, the dismountable fastening device referred to as D as a whole here ensures the assembly of the first component A and the second component B which will dock in a movement according to the arrow F1.

A first set of constituent elements of device D is mounted on component A and another set of constituent elements of device D is mounted on component B.

As shown, the first component A has a plurality of walls, one of which facing the component B. This latter wall has the elements of the device D mounted thereon. These elements consist of a threaded shouldered shaft 1 constituting the connection rod described above and having two ends 11 and 12.

A first end 11 is threaded and is fastened to the wall of component A by screwing. For this purpose, the wall is drilled and includes a fixed nut 2 (welded, crimped, or otherwise) on the inner surface of the wall and coaxially with the drilled hole. The threaded end 11 is screwed to the nut.

The second end of shaft 1 is spaced from the wall of component A and is fitted with a head 12. This head 12 provides a bearing surface.

A ring 3 is positioned on the shaft 1 between the wall of component A and the bearing surface provided by the head 12. This ring 3 has a conical outer surface.

According to the illustrated embodiment, said ring 3 is slidably mounted on the shaft 1.

According to another embodiment not illustrated, said ring 3 is fixed to the shaft and to the outer surface of the wall of component A.

As shown, the second component B has a plurality of walls, one of which comes opposite component A and which will be traversed for fastening purposes, by the second end and therefore the head 12 of the shaft 1. For this purpose, this latter wall is drilled to be traversed. A sleeve 4 passes through the second component B at this hole. The through hollow core 41 of this sleeve 4 emerges, it has a conicity. The second end, and therefore the head 12 of the shaft 1, penetrates through this hollow core 41 when docking according to arrow F1. At the portion located on the outside, this sleeve 4 comprises a support collar 42. At the portion located on the inside, said sleeve 4 is preformed with an inclined plane 43. Thus, the edge of the inner end of the sleeve 4 does not have a transverse surface perpendicular to the axis of the sleeve 4 but an inclined plane 43, i.e. a non-perpendicular surface with an inclination which will serve as a bearing surface for the wedge described below.

The minimum diameter of the hollow core 41 is defined to allow the head 12 of the shaft 1 to pass through. The conicity of the hollow core 41 is defined to allow its cooperation with the outer surface of the conical ring 3.

According to a preferred embodiment, said sleeve 4 is welded to the wall of component B.

Cooperating with said inclined plane 43, a wedge 7 movable in translation according to the double arrow F2, itself preformed with an inclined plane 71, comes to rest on the inclined plane 43 formed by the inner end of the sleeve 4 by inserting itself between the head 12 of the shaft 1 and the inclined plane 43 of the sleeve 4.

According to the embodiment shown, said wedge 7 has an axis stroke perpendicular to the assembly axis, i.e. the axis of the shaft 1.

As shown, said wedge 7 is configured as a fork whose branches are located on either side of the shaft 1 when cooperating with the bearing surface provided by the head 12 and with the inclined plane 43.

As shown, in opposition to the inclined plane 71, the branches of the fork are preformed with a contact surface, in contact with the bearing surface provided by the head 12 of the shaft 1, which contact surface is perpendicular to the axis of the assembly.

The translational movement of the wedge 7 is carried out by a movement-driving member which comprises a fixed nut 6 (welded or crimped on the second component B) and a threaded rod 5 screwing into the nut, said threaded rod 5 having two ends:
a first end comprising a head 51 allowing to control the rotation (double-arrow F3) of the threaded rod 5 from the outside of component B,
a second end 52 cooperating with wedge 7 located in component B close to edge 43 of sleeve 4,
   so that the rotation in one direction or the other of the screw 5 causes the translation in one direction or the other of the wedge 7.

The assembly implemented by such a device D is executed according to FIGS. 1 to 4 in sequence.

As shown in FIG. 1, the component A, considered as mobile, is positioned above the component B, considered as fixed, so that the axis of the shaft 1 secured on the component A is substantially coaxial with the axis of the sleeve 4 secured on component B. The wedge 7 is in a retracted, non-active, position and allows the head 12 of the shaft 1 to pass. The slidingly mounted conical ring 3 bears against the head 12.

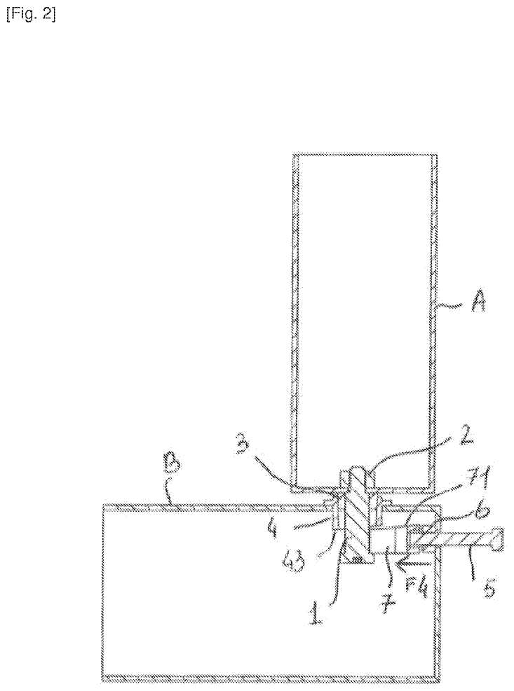

A docking movement along the arrow F1 makes it possible to reach the docked position illustrated in FIG. 2.

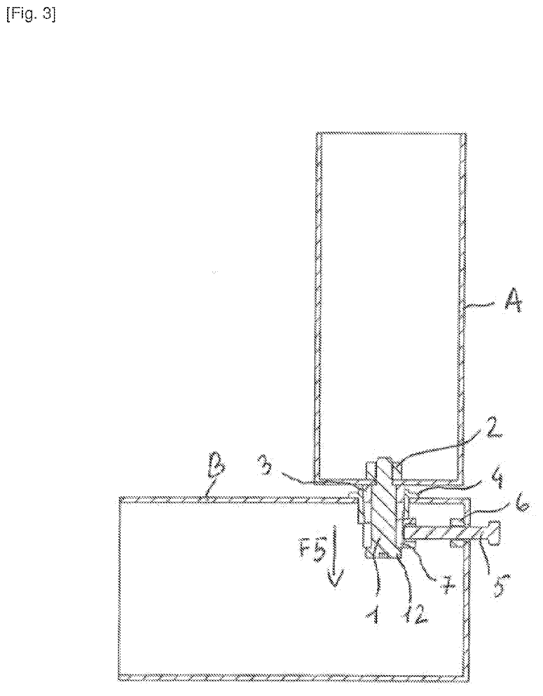

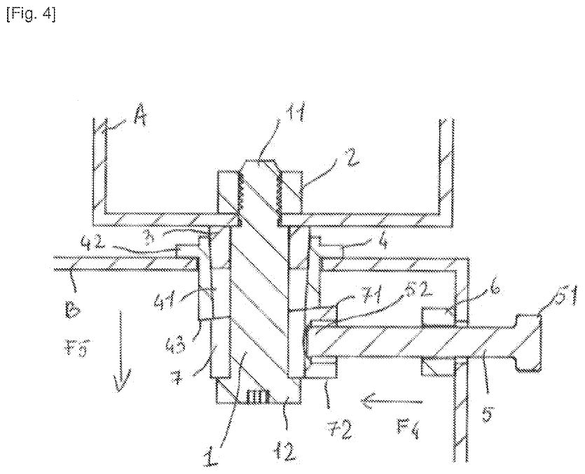

As shown, component A rests on the conical ring 3 that slid along the shaft 1 during docking and is engaged and retained by the conical hollow core 41 of the sleeve 4, the head 12 projects from the other side of the wall of component B and extends beyond the edge 43 of sleeve 4. The user can then rotate screw 5 in order to advance wedge 7 according to arrow F3 and obtain the tightened position shown by FIGS. 3 and 4.

As shown in these last figures, the wedge 7 is inserted between the sleeve 4 and the head 12. The stress exerted by the translation movement according to the arrow F4 is transformed into an axial stress on the shaft 1 by means of the inclined planes 43 and 71 in contact. This stress represented by the arrow F5 is exerted on the head 12 and therefore on the component A which exerts it on the ring 3 and contributes to the wedging thereof in the conical core 41 of the sleeve 4.

An advantage of such an embodiment lies in the fact that a variation in the tightening of the screw 5 will have a lesser influence on this wedging unless the components A and/or B are subjected to a tensile stress tending to separate them and therefore to separate the two cones. The fastening can be maintained despite said variations.

Disassembly consists in returning to the retracted position of wedge 7 and in exerting an axial traction between the two components for disassembly purposes. Head 12 takes the ring 3 away. The device is ready to be reassembled.

It is understood that the device which has just been described and represented above was for the purpose of disclosure rather than limitation. Of course, various arrangements, modifications and improvements may be made to the above example, without departing from the scope of the invention.

1. A fastening device for fastening together two components to be assembled, the device comprising a connection rod comprising two ends, a first end being fastened to a first component, the second end passing through the second component, the second end being provided with a bearing surface, the device comprising a clamping wedge associated with the second component, movable relative to the second component along an axis which is not parallel to the longitudinal axis of the connection rod and which is formed with an inclined plane, and, fixed to the second component, a sleeve which passes through the second component and into the hollow core of which the connection rod is introduced during assembly,
said wedge being inserted between the bearing surface of the second end of the connection rod and the second component by bearing on the edge of said sleeve, so that in the wedge's movement, said wedge, by means of the wedge's inclined plane, exerts an axial stress on the connection rod and secures the two components,
wherein
said connection rod comprises, between the bearing surface of the connection rod's second end and the first component to which the connection rod is fastened, a ring whose outer surface cooperates with the hollow core of said sleeve.

2. Device according to claim 1, wherein the axis of movement of the clamping wedge is perpendicular to the longitudinal axis of the connection rod.

3. Device according to claim 1, wherein said clamping wedge is configured as a fork whose branches are positioned on either side of the connection rod when they cooperate with the bearing surface.

4. Device according to claim 1, wherein the inclined plane of the wedge contacts the edge of the sleeve, itself forming an inclined plane, in order to better transmit the effort.

5. Device according to claim 1, wherein the outer surface of the ring is conical and cooperates with the hollow core of said sleeve, the latter being conical.

6. Device according to claim 1, wherein said clamping wedge is moved by a movement-driving member.

7. Device according to claim 6, wherein the movement-driving member comprises a threaded rod cooperating with an internally threaded fixed ring, fixed to the second component, said threaded rod comprising two ends:
a first end comprising a head making it possible to rotate the threaded rod,
a second end cooperating with the wedge,
so that the rotation in one direction or the other of the threaded rod causes the translation in one direction or the other of the wedge.

8. Device according to claim 1, wherein said connection rod is a shouldered threaded shaft with a first threaded end which is fastened to the first component and a second end comprising a head providing said bearing surface.

9. Device according to claim 2, wherein the inclined plane of the wedge contacts the edge of the sleeve, itself forming an inclined plane, in order to better transmit the effort.

10. Device according to claim 9, wherein said connection rod is a shouldered threaded shaft with a first threaded end which is fastened to the first component and a second end comprising a head providing said bearing surface.

11. Device according to claim 2, wherein said connection rod is a shouldered threaded shaft with a first threaded end which is fastened to the first component and a second end comprising a head providing said bearing surface.

12. Device according to claim 3, wherein said connection rod is a shouldered threaded shaft with a first threaded end which is fastened to the first component and a second end comprising a head providing said bearing surface.

13. Device according to claim 4, wherein said connection rod is a shouldered threaded shaft with a first threaded end which is fastened to the first component and a second end comprising a head providing said bearing surface.

14. Device according to claim 5, wherein said connection rod is a shouldered threaded shaft with a first threaded end which is fastened to the first component and a second end comprising a head providing said bearing surface.

15. Device according to claim 6, wherein said connection rod is a shouldered threaded shaft with a first threaded end which is fastened to the first component and a second end comprising a head providing said bearing surface.

16. Device according to claim 7, wherein said connection rod is a shouldered threaded shaft with a first threaded end which is fastened to the first component and a second end comprising a head providing said bearing surface.
